(19) United States
(12) Patent Application Publication
(10) Pub. No.: US 2013/0180373 A1
(43) Pub. Date: Jul. 18, 2013

(54) CUTTING PLOTTER AND NON-TRANSITORY COMPUTER-READABLE MEDIUM

(71) Applicant: BROTHER KOGYO KABUSHIKI KAISHA, Nagoya-shi (JP)

(72) Inventors: Daisuke Abe, Nagoya-shi (JP); Yasuhiko Kawaguchi, Nagoya-shi (JP); Yoshinori Nakamura, Toyohashi-shi (JP); Mitsuhiro Iida, Nagoya-shi (JP); Masashi Tokura, Konan-shi (JP)

(73) Assignee: BROTHER KOGYO KABUSHIKI KAISHA, Nagoya-shi (JP)

(21) Appl. No.: 13/740,391

(22) Filed: Jan. 14, 2013

(30) Foreign Application Priority Data
Jan. 16, 2012 (JP) 2012-006123

(51) Int. Cl. B26D 5/00

(52) U.S. Cl. CPC B26D 5/005
USPC 83/76.1

(57) ABSTRACT

A cutting plotter includes a cut mechanism, an operation device, a processor and a memory. The cut mechanism is to cut a pattern from a cut target. The holding member is to hold the cut target and set on the cutting plotter. The operation device is to receive input. The memory stores computer-readable instructions that instruct the cutting plotter to execute steps including designating, selecting, determining, and instructing. The designating includes designating a partial area based on an input. The partial area is a part of a holding area. The selecting includes selecting a certain pattern from plural patterns based on an input. The determining includes determining a position, included in the partial area, of the certain pattern on the cut target. The instructing includes instructing the cut mechanism to cut the certain pattern from the position on the cut target determined by the determining.

### CROSS-REFERENCE TO RELATED APPLICATIONS

This application claims priority to Japanese Patent Application No. 2012-6123 filed on Jan. 16, 2012, the content of which is hereby incorporated herein by reference in its entirety.

### BACKGROUND

1. Technical Field

The present disclosure relates to a cutting plotter, which cuts a pattern from a cut target by a cutting blade, and a non-transitory computer-readable medium storing computer-readable instructions executable by a processor of a cutting plotter.

2. Description of Related Art

Cutting plotters, which automatically cut a sheet (e.g., a paper), have been known. The sheet is affixed to a holding member which has an adhesive layer on a surface thereof. The cutting plotter pinches both edge of the holding member in an up-down direction by pinch rollers to moves the holding member in a front-back direction. The cutting plotter moves a carriage including a cutting blade in a right-left direction which is perpendicular to the front-back direction. A desired pattern is cut from the sheet by the relative movement between the carriage and the holding member.

In conventional cutting plotters, it is not considered that cutting a pattern from the sheet that is affixed to anywhere of the holding member. It is not considered as well that plural sheets adhere to the single holding member, and patterns are cut from the plural sheets. Thus, a user needs to set positions, from which patterns are cut, on each of one or more sheets that adhere to the holding member, requiring cumbersome operations.

### SUMMARY

A purpose of the present disclosure is to provide a cutting plotter and a non-transitory computer-readable medium storing computer-readable instructions executable by a processor of a cutting plotter that make it possible to easily and accurately set positions of patterns on a cutting target held on the holding member.

A cutting plotter includes a cut mechanism, an operation device, a processor and a memory. The cut mechanism is configured to cut a pattern from a cut target by relatively moving a cutting blade and a holding member. The holding member is configured to hold the cut target and being to be set on the cutting plotter. The operation device is configured to receive input. The memory stores computer-readable instructions therein, wherein the computer-readable instructions instruct the cutting plotter to execute steps including designating, selecting, determining, and instructing. The designating includes designating a partial area based on an input received by the operation device. The partial area is a pan of a holding area in which the cut target is held. The selecting includes selecting, a certain pattern from plural patterns based on an input received by the operation device. The determining includes determining a position, included in the partial area, of the certain pattern on the cut target. The instructing includes instructing the cut mechanism to cut the certain pattern from the position on the cut target determined by the determining.

### BRIEF DESCRIPTION OF THE DRAWINGS

In the accompanying drawings:

FIG. 1 is a perspective view of the inner structure of a cutting plotter according to one embodiment;

FIG. 2 is a plan view of the cutting plotter;

FIG. 3 is a perspective view of a cutter holder;

FIG. 4 is a sectional view of the cutter holder, showing the case where the cutter has been moved upward;

FIG. 5 is a side view of the cutter holder and its vicinity, the case where the cuter has been moved downward;

FIG. 6 is an enlarged front view of a gear;

FIG. 7 is an enlarged view of a distal end of the cutter and its vicinity during cutting;

FIGS. 8A and 8B are plan views of two types of holding sheets respectively;

FIG. 9 is a block diagram showing an electrical arrangement of the cutting plotter;

FIG. 10A shows a data structure of holding area information;

FIG. 10B explains area data;

FIG. 10C shows a positional relation between a pattern and a partial area;

FIG. 11A shows a structure of cutting data of the pattern;

FIG. 11B explains the cutting data of the pattern;

FIG. 12 is a flowchart showing the processing for setting an arrangement position of the pattern;

FIG. 13 shows an example of a holding sheet selecting screen;

FIG. 14 shows an example of a pattern selecting screen; and

FIG. 15 shows an example of an arrangement display screen

### DETAILED DESCRIPTION

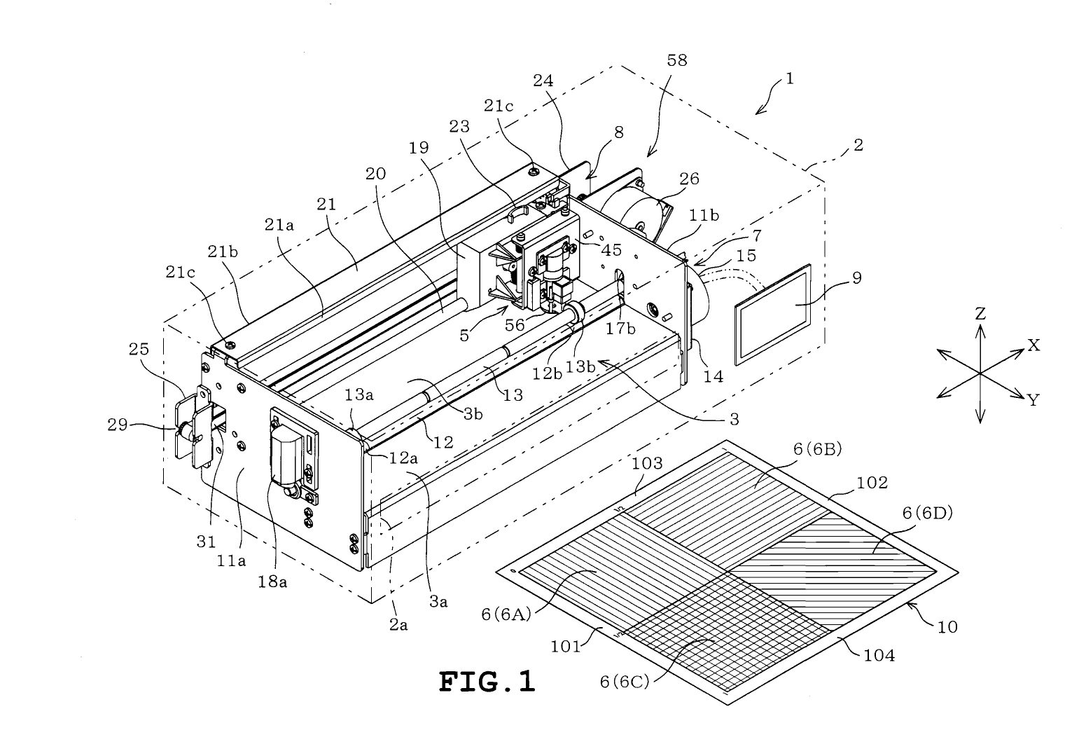

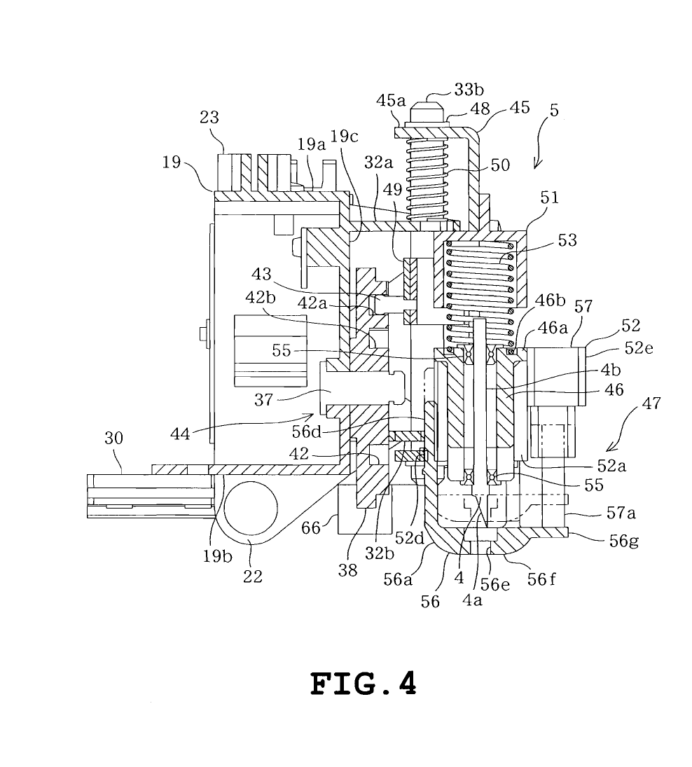

One embodiment will be described with reference to FIGS. 1 to 15. Referring to FIG. 1, a cutting, plotter 1 serving as a cutting, apparatus includes a body cover 2 as a housing, a platen 3 enclosed in the body cover 2 and a cutter holder 5 also enclosed in the body cover 2. The cutting plotter 1 also includes first and second moving units 7 and 8 for moving a cutter 4 (see FIG. 4) of the cutter holder 5 and a cut target 6 to be cut, relative to each other. The body cover 2 is formed into the shape of a horizontally long rectangular box and has a front formed with a horizontally long opening 2a extending in an X direction. A holding sheet 10 holding the cut target 6 is configured to be set through the opening 2a onto an upper side of the platen 3. In the following description, a direction in which the cut target 6 is moved by the first moving unit 7 will be referred to as “front-back direction.” More specifically, the side of the cutting plotter 1 where the opening 2a is located will be referred to as “front” and the opposite side will be referred to as “back.” The front-back direction will be referred to as “Y direction.” The right-left direction perpendicular to the Y direction will be referred to as “X direction.” An up-down direction perpendicular to the front-back and right-left directions will be referred to as “Z direction.”

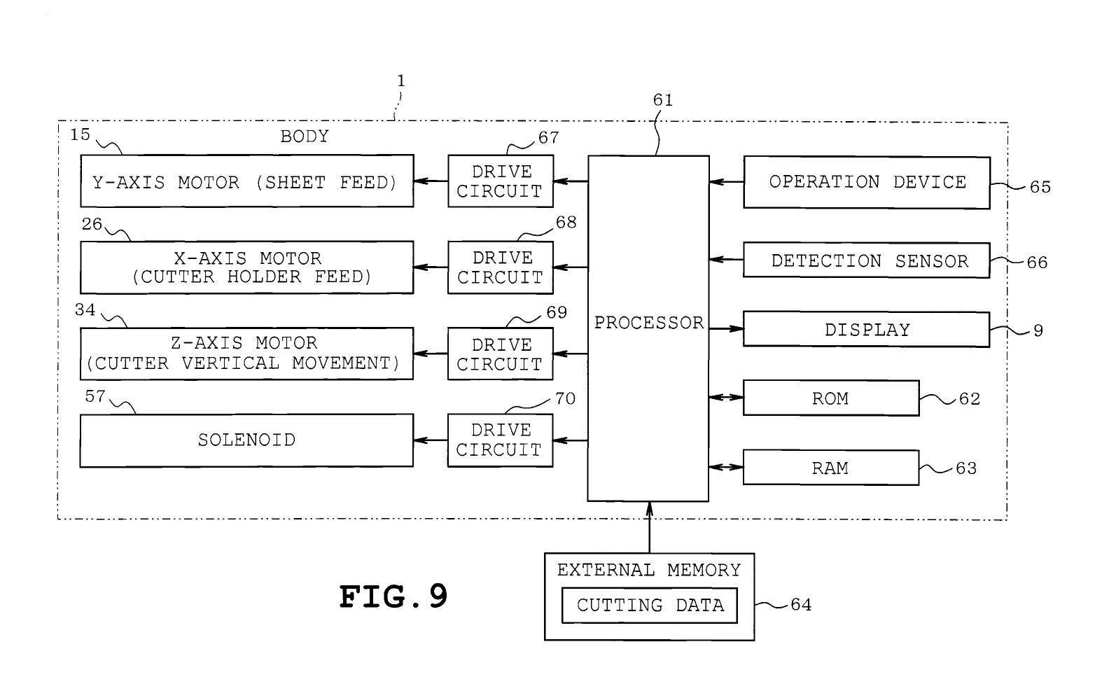

On a right part of the body cover 2 are provided a full-color liquid crystal display (LCD) 9 and an operation device 65 including a plurality of operation switches (see FIG. 9). The LCD 9 is configured as a display unit displaying various patterns, various messages necessary for the user, and the like. The operation device 65 serves as an input unit for the user to supply various instructions, selections and inputs to the cutting plotter 1. Operation of the operation device 65 or the operation switches realizes selection of a pattern displayed on the LCD 9, set of various parameters, instruction of functions and the like.

The platen 3 includes a pair of front and rear plate members 3a and 3b and has an upper surface which is configured into an X-Y plane serving as a horizontal plane. The holding sheet 10 holding the cut target 6 is set on the upper surface of the platen 3. The holding sheet 10 is received by the platen 3 when the cut target 6 is cut. The holding sheet 10 has an upper surface with an adhesive layer 10v formed by applying an adhesive agent to an inside region thereof except for peripheral edges 101 to 104 as will be described in detail later. The user affixes the cut target 6 to the adhesive layer 10v, whereby the cut target 6 is held by the holding sheet 10.

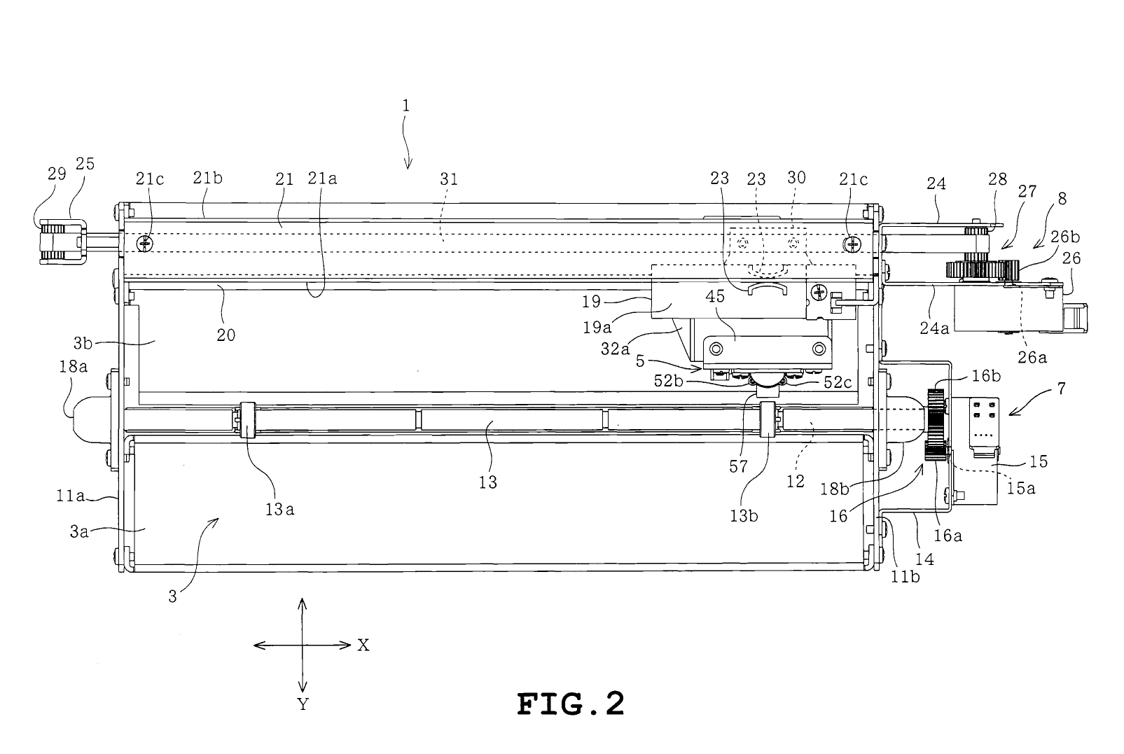

The first moving unit 7 moves the holding sheet 10 on the upper surface of the platen 3 in the Y direction. A driving roller 12 and a pinch roller 13 are provided on right and left sidewalls 11b and 11a so as to be located between plate members 3a and 3b of the platen 3 respectively. The driving roller 12 and the pinch roller 13 extend in the X direction and are rotatably supported on the sidewalls 11b and 11a respectively. The driving roller 12 and the pinch roller 13 are disposed so as to be parallel to the X-Y plane and so as to be vertically arranged. The driving roller 12 is located under the pinch roller 13. A first crank-shaped mounting frame 14 is mounted on the right sidewall 11b so as to be located on the right of the driving roller 12 as shown in FIG. 2. A Y-axis motor 15 is fixed to an outer surface of the mounting frame 14.

A stepping motor is used as the Y-axis motor 15, for example. The Y-axis motor 15 has a rotating shaft 15a extending through a hole (not shown) of the first mounting frame 14 and further has a distal end provided, with a gear 16a. The driving roller 12 has a right end to which is secured another gear 16b which is brought into mesh engagement with the gear 16a. These gears 16a and 16b constitute a first reduction gear mechanism 16. The pinch roller 13 is guided by guide grooves 17b formed in the right and left sidewalls 11b and 11a so as to be movable upward and downward. Only the right guide groove 17b is shown in FIG. 1. Two spring accommodating members 18a and 18b are mounted on the right and left sidewalls 11b and 11a in order to cover the guide groove 17b from the outside respectively. The pinch roller 13 is biased downward by compression coil springs (not shown) accommodated in the spring accommodating portions 18a and 18b respectively. The pinch roller 13 is provided with pressing portions 13a and 13b which are brought into contact with both right and left edges 102 and 101 of the holding sheet 10, thereby pressing the edges 102 and 101, respectively The pressing portions 13a and 13b have slightly larger outer diameters than the other portion of the pinch roller 13 respectively. The driving roller 12 is also formed with pressing portions 12a and 12b located so as to correspond to the pressing portions 13a and 13b respectively.

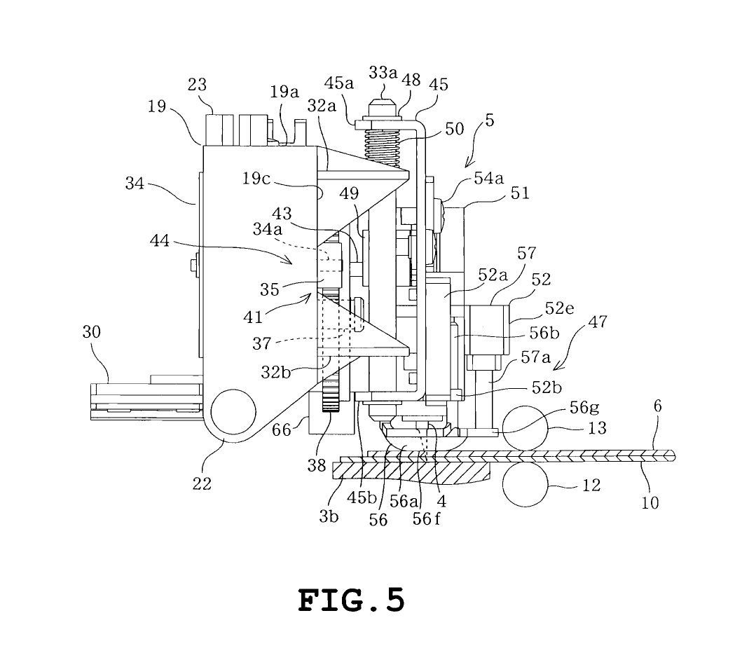

The driving roller 12 and the pinch roller 13 press the holding sheet 10 from below and from above by the biasing force of the compression coil springs thereby to hold the holding sheet 10 therebetween (see FIG. 5). Upon drive of the Y-axis motor 15, normal or reverse rotation of the Y-axis motor 15 is transmitted via the first reduction gear mechanism 16 to the driving roller 12, whereby the holding sheet 10 is moved backward or forward together with the cut target 6. The first moving unit 7 is thus constituted by the driving roller 12, the pinch roller 13, the Y-axis motor 15 the first reduction gear mechanism 16, the compression coil springs and the like.

The second moving unit 8 moves a carriage 19 supporting the cutter holder 5 in the X direction. A guide shaft 20 and a guide frame 21 both extending in the right-left direction are provided between the right and left sidewalls 11b and 11a, as shown in FIGS. 1 and 2. The guide shaft 20 and the guide frame 21 are located nearer to the rear of the apparatus than the driving roller 12 and the pinch roller 13 are with respect to the Y direction. The guide shaft 20 is disposed in parallel with the driving roller 12 and the pinch roller 13. The guide shaft 20 located right above the platen 3 extends through a hole of a lower part of the carriage 19 (a through hole 22 as will be described later). The guide frame 21 has a front edge 21a and a rear edge 21b both folded downward such that the guide frame 21 has a generally C-shaped section. The front edge 21a is disposed in parallel with the guide shaft 20. The guide frame 21 is adapted to guide an upper part (guided members 23 as will be described later) of the carriage 19 by the front edge 21a. The guide frame 21 is fixed to upper ends of the sidewalls 11a and 11b by screws 21c respectively.

A second mounting frame 24 is mounted on the right sidewall 11b in the rear of the cutting plotter 1, and an auxiliary frame 25 is mounted on the left sidewall 11a in the rear of the cutting plotter 1, as shown in FIG. 2. An X-axis motor 26 and a second reduction gear mechanism 27 are mounted on the second mounting frame 24. The X-axis motor 26 may be a stepping motor, for example and is fixed to a front of a front mounting piece 24a. The X-axis motor 26 includes a rotating shaft 26a which extends through a hole (not shown) of the mounting piece 24a and has a distal end provided with a gear 26b which is brought into mesh engagement with the second reduction gear mechanism 27. A pulley 28 is rotatably mounted on the second reduction gear mechanism 27, and another pulley 29 is rotatably mounted on the left auxiliary frame 25 as viewed in FIG. 2. An endless timing belt 31 is connected to a rear end (a mounting portion 30 as will be described later) of the carriage 19 and extends between the pulleys 28 and 29.

Upon drive of the X-axis motor 26, normal or reverse rotation of the X-axis motor 26 is transmitted via the second reduction gear mechanism 27 and the pulley 28 to the timing belt 31, whereby the carriage 19 is moved leftward or rightward together with the cutter holder 5. Thus, the carriage 19 and the cutter holder 5 are moved in the X direction. The second moving unit 8 is constituted by the above-described guide shaft 20, the guide frame 21, the X-axis motor 26, the second reduction gear mechanism 27, the pulleys 28 and 29, the timing belt 31, the carriage 19 and the like.

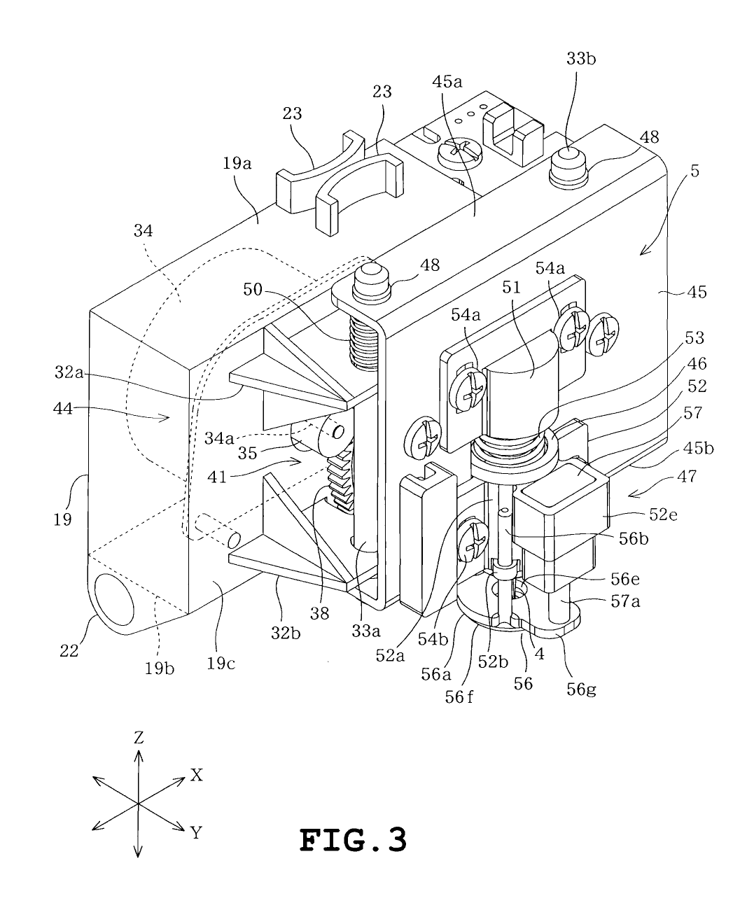

The cutter holder 5 is disposed on the front of the carriage 19 and is supported so as to be movable in a vertical direction serving as the Z direction. The carriage 19 and the cutter holder 5 will be described with reference to FIGS. 3 to 7 as well as FIGS. 1 and 2. The carriage 19 is formed into the shape of a substantially rectangular box with an open rear as shown in FIGS. 3 and 4. The carriage 19 has an upper wall 19a with which two guided members 23 are formed into an arc shape as viewed in a planar view. The guided members 23 are formed into a pair of front and rear ribs protruding upward from the upper wall 19a. The guided members 23 are symmetrically disposed with a front edge 21a of the guide frame 21 being interposed therebetween. The carriage 19 has a bottom wall 19b further having a downwardly expanding portion which is formed with a pair of right and left through holes 22 through which the guide shaft 20 is inserted. An attaching portion 30 (see FIGS. 4 and 5) is mounted on the bottom wall 19b of the carriage 19 so as to protrude backward. The attaching portion 30 is to be coupled with the timing belt 31. The carriage 19 is thus supported by the guide shaft 20 inserted through the holes 22, so as to be slidable in the right-left direction and further supported by the guide frame 21 held between the guided members 23, so as to be prevented from being rotated about the guide shaft 20.

The carriage 19 has a front wall 19c with which a pair of upper and lower support portions 32a and 32b are formed so as to extend forward as shown in FIGS. 3 to 5, etc. A pair of right and left support shafts 33b and 33a extending through the respective support portions 32b and 32a are mounted on the carriage 19 so as to be vertically movable. A Z-axis motor 34, which may be a stepping motor, for example, is accommodated in the carriage 19 backward thereby to be housed therein. The Z-axis motor 34 has a rotating shaft 34a (see FIGS. 3 and 5) which extends through a hole (not shown) of the front wall 19c of the carriage 19. The rotating shaft 34a has a distal end provided with a gear 35. Furthermore, the carriage 19 is provided with a gear shaft 37 which extends through a hole (not shown) formed in a slightly lower part of the gear 35 relative to the central part of the front wall 19c as shown in FIG. 4. A gear 38 is rotatably mounted on the gear shaft 37 and adapted to be brought into mesh engagement with the gear 35 in front of the front wall 19c. The gear shaft 37 is retained by a retaining ring (not shown) mounted on a front end thereof. The gears 35 and 38 constitute a third reduction mechanism 41 (see FIGS. 3 and 5).

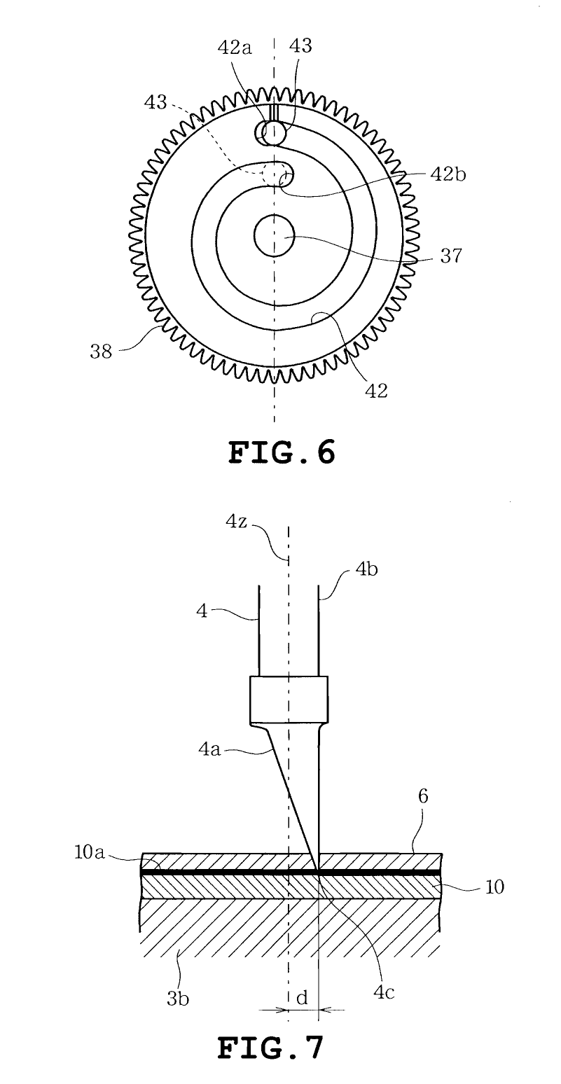

The gear 38 is formed with a spiral groove 42 as shown in FIG. 6. The spiral groove 42 is a cam groove formed into a spiral shape such that the spiral groove 42 comes closer to the center of the gear 38 as it is turned rightward from a first end 42a toward a second end 42b. An engagement pin 43 which is vertically moved together with the cutter holder 5 engages the spiral groove 42 as will be described in detail later (see FIG. 4). Upon normal or reverse rotation of the Z-axis motor 34, the gear 38 is rotated via the gear 35. Rotation of the gear 38 vertically slides the engagement pin 43 in engagement with the spiral groove 42. With the vertical slide of the gear 38, the cutter holder 5 is moved upward or downward together with the support shafts 33a and 33b. In this case, the cutter holder 5 is moved between a raised position (see FIGS. 4 and 6) where the engagement pin 43 is located at the first end 42a of the spiral groove 42 and a lowered position (see FIGS. 5 and 6) where the engagement pin 43 is located at the second end 42b. A third moving unit 44 which moves the cutter holder 5 upward and downward is constituted by the above-described third reduction mechanism 41 having the spiral groove 42, the Z-axis motor 34, the engagement pin 43, the support portions 32a and 32b, the support shafts 33a and 33b, etc.

The cutter holder 5 includes a holder body 45 mounted on the support shafts 33a and 33b, a movable cylindrical portion 46 which has as cutter 4 (a cutting blade) and is held by the holder body 45 so as to be vertically movable and a pressing device 47 which presses the cut target 6. More specifically, the holder body 45 has an upper end 45a and a lower end 45b both of which are folded backward such that the holder body 45 is generally formed into a C-shape, as shown in FIGS. 3 to 5, etc. The upper and lower ends 45a and 45b are immovably fixed to the support shafts 33a and 33b by retaining rings 48 fixed to upper and lower ends of the support shafts 33a and 33b, respectively. The support shaft 33b has a middle part to which is secured a coupling member 49 provided with a backwardly directed engagement pin 43 as shown in FIGS, 4 and 5. The holder body 45, the support shafts 33a and 33b, the engagement pin 43 and the coupling member 49 are formed integrally with one another. The cutter holder 5 is vertically moved by the third moving unit 44 in conjunction with the engagement pin 43. Furthermore, two compression coil springs 50 serving as biasing members are mounted about the support shafts 33a and 33b so as to be located between an upper surface of the support portion 32a and an upper end 45a of the holder body 45, respectively. The entire cutter holder 5 is elastically biased upward by a biasing force of the compression coil springs 50 relative to the carriage 19.

Mounting members Si and 52 provided for mounting the movable cylindrical portion 46, the pressing device 47 and the like are fixed to the middle portion of the holder body 45 by screws 54a and 54b respectively, as shown in FIG. 3. The lower mounting member 52 includes a cylindrical portion 52a (see FIG. 4) which supports the movable cylindrical portion 46 so that the movable cylindrical portion 46 is vertically movable. The movable cylindrical portion 46 has a diameter that is set so that the movable cylindrical portion 46 is brought into a sliding contact with the inner peripheral surface of the cylindrical portion 52a. The movable cylindrical portion 46 has an upper end formed with a flange 46a which projects radially outward to be supported on an upper end of the cylindrical portion 52a. A spring, shoe 46b is provided on an upper end of the flange 46a. A compression coil spring 53 is interposed between the upper mounting member 51 and the spring shoe 46b of the movable cylindrical portion 46 as shown in FIG. 4. The compression coil spring 53 biases the movable cylindrical portion 46 and the cutter 4 mounted on the cylindrical portion 46 to the lower cut target 6 side while allowing the upward movement of the movable cylindrical portion 46 against the biasing force when an upward force acts on the cutter 4 from the cut target 6 side.

The cutter 4 is mounted on the movable cylindrical portion 46 so as to extend through the movable cylindrical portion 46. The cutter 4 includes a cutter shaft 4b and a blade 4a both formed integrally with the cutter 4 and extends in an axial direction of movable cylindrical portion 46. The cutter shaft 4b is formed into the shape of a long round bar and is longer than the movable cylindrical portion 46. The cutter shaft 4b has a lower end on which the blade 4a is formed. The blade 4a is formed into a substantially triangular shape and has a lowermost end serving as a blade edge 4c which is formed so as to assume a position shifted by a distance d from a central axis 4z of the cutter shaft 4b, as shown in FIG. 7. The movable cylindrical portion 46 has two bearings 55 (see FIG. 4) mounted on inner upper and lower ends thereof respectively. The cutter 4 is mounted on the bearings 55 so as to be rotatable about the vertical central axis 4z, that is, a Z-axis. The cutter 4 thus presses the blade edge 4c against the X-Y plane or the surface of the cut target 6 from the Z direction perpendicular to the X-Y plane. Furthermore, the cutter 4 has a height that is set so that when the cutter holder 5 has been moved to the lowered position, the blade edge 4c passes through the cut target 6 on the holding sheet 10 but does not reach the upper surface of the plate member 3b of the platen 3, as shown in FIG. 7. On the other hand, the blade edge 4c of the cutter 4 is moved upward with movement of the cutter holder 5 to the raised position, thereby being spaced from the cut target 6 (see FIG. 4).

The mounting member 52 has three guide holes 52b, 52c and 52d (see FIGS. 2 to 5) which are formed at regular intervals in a circumferential edge of the lower end of the cylindrical portion 52a. A pressing member 56 is disposed under the cylindrical portion 52a and has three guide bars 56b, 56c and 56d which are to be inserted into the guide holes 52b to 52d respectively. The pressing member 56 includes a lower part serving as a shallow bowl-shaped pressing portion body 56a. The aforementioned equally-spaced guide bars 56b to 56d are formed integrally on the circumferential end of the top of the pressing portion body 56a. The guide bars 56b to 56d are guided by the respective guide holes 52b to 52d, so that the pressing member 56 is vertically movable. The pressing portion body 56a has a central part formed with a through hole 56e which vertically extends to cause the blade 4a to protrude downward therethrough. The pressing portion body 56a has an underside serving, as a contact portion 56f which is brought into contact with the cut target 6 around the blade 4a. The contact portion 56f is formed into a horizontal flat surface in parallel with the X-V plane and is brought into surface contact with the cut target 6. The contact portion 56f is made of a fluorine resin such as Teflon® so as to have a lower coefficient of friction, whereupon the contact portion 56f is rendered slippery relative to the cut target 6.

The pressing portion body 56a has a connection 56g which is formed integrally on the circumferential edge thereof so as to extend forward, as shown in FIGS. 3 to 5 etc. On the other hand, the mounting member 52 has a front mounting portion 52e for a solenoid 57, integrally formed therewith. The front mounting portion 52e is located in front of the cylindrical portion 52a and above the connection 56g. The solenoid 57 serves as an actuator for vertically moving the pressing member 56 thereby to press the cut target 6. The solenoid 57 and the pressing member 56 constitute a pressing device 47 together with a processor 61 or a control circuit which will be described later. The solenoid 57 is mounted on the front mounting portion 52e so as to be directed downward. The solenoid 57 includes a plunger 57a having a distal end fixed to an upper surface of the connection 56g. The solenoid 57 is actuated with the cutter holder 5 assuming the lowered, position as will be described in more detail later. In this case, the pressing member 56 is moved downward together with the plunger 57a thereby to press the cut target 6 with a predetermined pressure (see FIG. 5). On the other hand, when the plunger 57a is located above during the non-actuated state of the solenoid 57, the pressing member 56 releases the cut target 6 from application of the pressing force. When the cutter holder 5 is moved to the raised position during the non-actuated state of the solenoid 57 (see two-dot chain line in FIG. 4), the pressing member 56 is completely spaced from the cut target 6. A cut mechanism 58 (see FIG. 1) is constituted by the above-described cutter 4, the first to third moving units 7, 8 and 44, the processor 61, the pressing device 47 and the like.

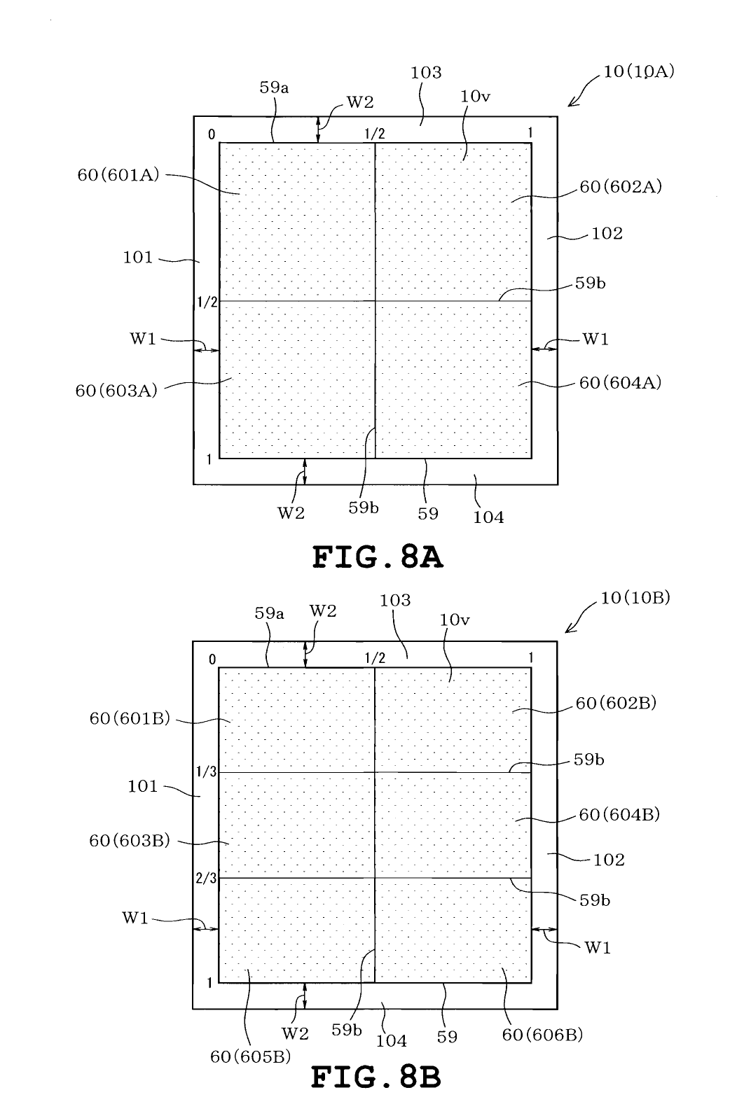

The holding sheet 10 will now be described in detail with reference to FIGS. 8A and 8B as well as FIGS. 1 to 7. FIGS. 8A and 8B show two types of holding sheets 10A and 10B respectively. A plurality of types of holding sheets is prepared other than the holding sheets 10A and 10B in the embodiment although not shown. All the holding sheets will be referred to as “holding sheet 10” for convenience of description since these sheets are configured in the same manner except for markers which will be described later.

The holding sheet 10 is made of, for example, a synthetic resin and formed into a fiat rectangular plate shape. In the embodiment, the holding sheet 10 is square in shape for the sake of easiness in the description. The holding sheet 10 serving as a holding member has an adhesive layer 10v on a surface thereof (an tipper surface, for example) opposed to the cutter 4 (see FIG. 7). The adhesive layer 10v is formed in an area of the holding sheet 10 located inside the outer edge of the holding sheet 10 by a predetermined distance (see W1 and W2 in FIGS. 8A and 8B). As a result, the holding sheet 10 is formed into a rectangular shape as viewed in a planar view. The adhesive layer 10v is made of a transparent adhesive material, for example and serves as a holding area for removably holding various types of cut targets 6. The adhesive layer 10v has an adhesion that is set to a small value such that the cut target 6 can easily be removed from the adhesive layer 10v without breakage of the cut target 6. Thus, when cut by the cutting plotter 1, the cut target 6 is held by the adhesion of the adhesive layer 10v and the pressing force of the pressing device 47 so as to be immovable relative to the holding sheet 10.

The holding sheet 10 has a peripheral edge including right and left edges 102 and 101 and front and rear edges 104 and 103 in each of which no adhesive layer 10v is provided. The right and left edges 102 and 101 serve as supported portions which are vertically held by the pressing portions 12a to 13b of the drive roller 12 and the pinch roller 13 thereby to be supported.

The holding sheet 10 is provided with a base line 59 which defines the area of the adhesive layer 10v as the holding area. The base line 59 includes a first base line 59a which extends along an outer edge of the holding area and has a square shape, and a second base line 59b which divides the holding area into a plurality of parts each having a predetermined size. The base lines 59a and 59b are printed directly on an upper surface of the holding sheet 10 in black, for example. The base lines 59a and 59b are visible through the transparent adhesive layer 10v.

The holding area is divided into four square partial areas 60 by the first and second base lines 59a and 59b in the holding sheet 10A of FIG. 8A. More specifically, the second base lines 59b are formed into a cross shape with an intersection generally corresponding with a center of the holding area, whereby the four partial areas 60 serve as first to fourth partial areas 601A to 604A which have the same size and configuration. Numerals are printed on the edges 101 and 103 of the holding sheet 10A so as to be located on the left and upper sides. The numerals have a function as identification marks as exemplified by “0,” “½” and “1,” The numeral, “0” indicates a left rear apex of the holding area. The left rear apex of the holding area corresponds to an apex of the first base line 59a. The apex serves as an origin of the holding sheet 10A as will be described later. The other numerals are also printed on the edges 101 and 103 so as to be located on the left and upper edges. Accordingly, the numerals serve as the identification marks to identify the locations and sizes of the partial areas 601A to 604A respectively. Thus, the first and second base lines 59a and 59b and the identification marks are markers corresponding to divided patterns of the partial areas 601A to 604A respectively.

Referring now to FIG. 8B, the holding area is divided into six rectangular partial areas 60 by the first and second base lines 59a and 59b. The second base line 59 of the holding sheet 10B is also formed so as to divide the holding area at regular intervals with respect to both right-left and front-back directions. The six partial areas 60 serve as first to sixth partial areas 601B to 606B. Furthermore, markers are also affixed to edges 101 and 103 of the holding sheet 10B in the same manner as those of the holding sheet 10A. The markers include numeral “0” indicative of the origin of the holding sheet 10B and numerals “⅓,” “⅔” and . . . which become rough indications of the locations or sizes of the partial areas 601B to 606B.

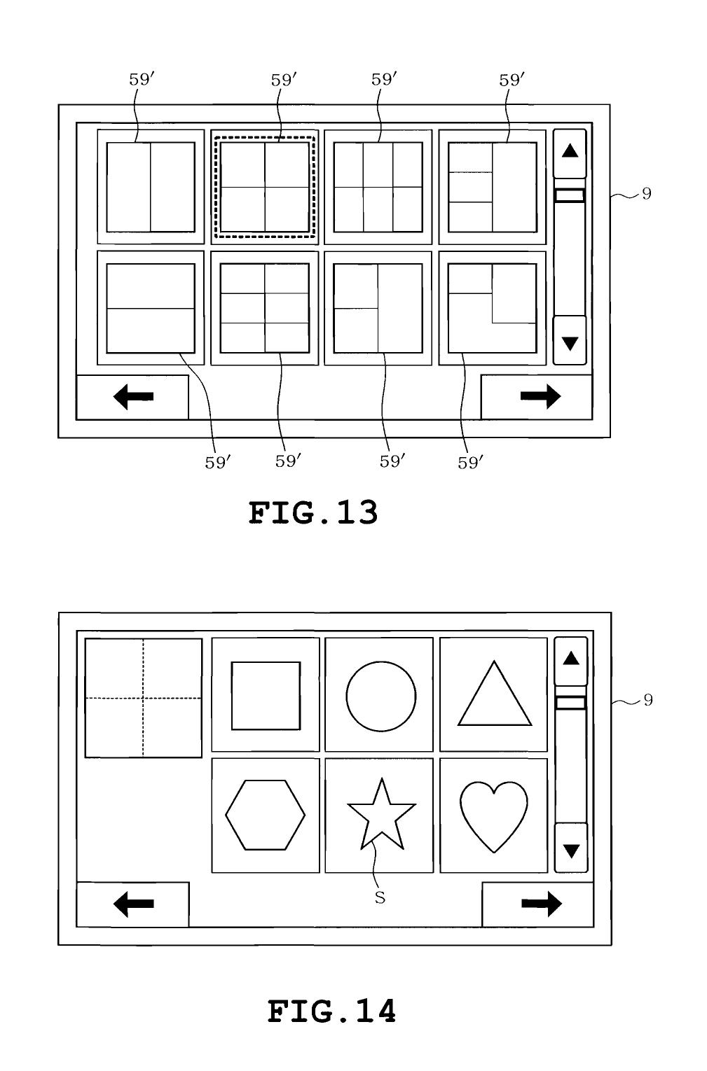

The holding sheet 10 includes various divided patterns along with the holding sheets 10A and 10B each having a lattice-shaped divided pattern as described above. The holding sheet 10 includes one in which the holding areas are set so as to differ in the size and shape by the second base lines 59b serving as dividing lines (see FIG. 13). The divided pattern may be configured so that the partial areas 60 are formed into polygonal shapes except for a rectangular shape (see a right lower divided pattern in FIG. 13). Furthermore, the second base line 59b may be a line inclined relative to the first base line 59a or a curved line, instead of the straight line. Thus, various shapes of partial areas 60 may be formed.

The cutting plotter 1 is provided with a detection sensor 66 (see FIG. 9) which detects the holding sheet 10 set through the opening 2a. The processor 61 sets, as an origin (X0, Y0), the point “0” of the set holding sheet 10, based on a detection signal generated by the detection sensor 66. Thus, the coordinate system of the cutting plotter 1 has the origin of the holding sheet 10 as a reference point. The cutter 4 and the cut target 6 are then moved relative to each other in the X-Y coordinate system by the first and second moving units 7 and 8 on the basis of the cutting data which will be described later. The direction from the left toward the right on the holding sheet 10 is referred to as “a positive direction of the X-axis” in the coordinate system of the cutting plotter 1. The direction from the back to the front on the holding sheet 10 or the direction in which the holding sheet 10 is moved backward is referred to as “a positive direction of the Y-axis.”

An electrical arrangement of the control system of the cutting plotter 1 will now be described with reference to the block diagram of FIG. 9. The processor 61 controlling the entire cutting plotter 1 is mainly composed of a computer (CPU). To the processor 61 are connected a ROM 62, a RAM 63 and an external memory 64. The ROM 62 stores a cutting control program, a display control program, an arrangement setting program which will be described later, and the like. The RAM 63 temporarily stores various data and program necessary for execution of each processing. The processor 61 may be configured by an application specific integrated circuit (ASIC).

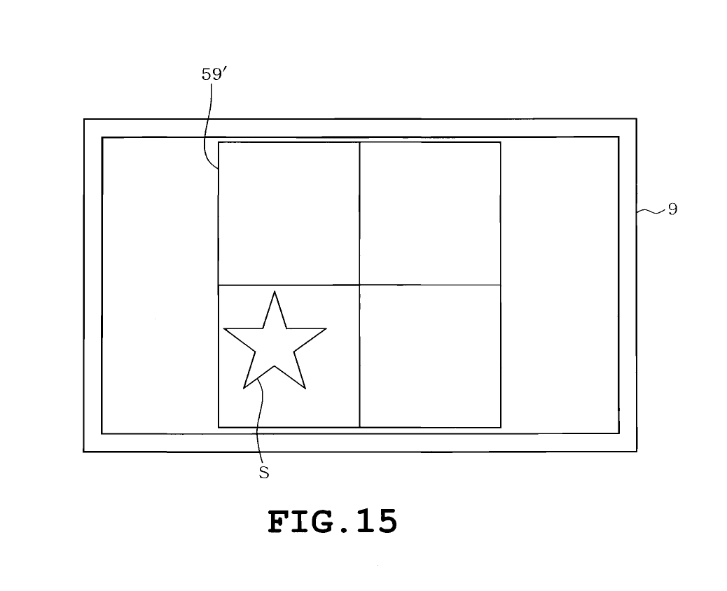

To the processor 61 are connected various operation switches of the operation device 65, the detection sensor 66 and the display 9. The display 9 is configured to display a pattern selecting, screen (see FIG. 14) which will be described later, a holding sheet selecting screen (see FIG. 13) and an arrangement setting screen (see FIG. 15). While viewing the screen of the display 9, the user operates one or more of the operation switches of the operation device 65 to select a desired pattern and a type of the holding sheet 10.

To the processor 61 are further connected drive circuits 67, 68, 69 and 70 driving the Y-axis motor 15, the X-axis motor 26, the Z-axis motor 34 and the solenoid 57 respectively. The processor 61 executes the cutting, control program to control the Y-axis motor 15, the X-axis motor 26, the Z-axis motor 34 and the solenoid 57, whereby a cutting operation is automatically carried out for the cut target 6 on the holding sheet 10.

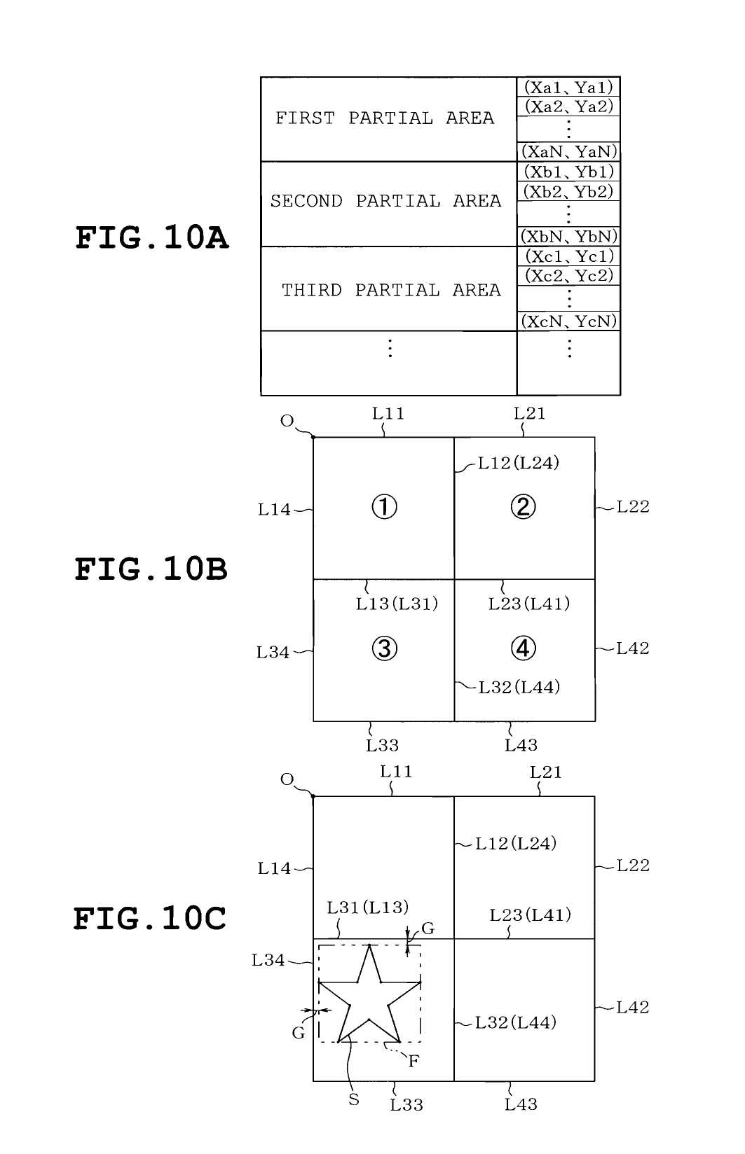

The external memory 64 stores holding area information regarding the aforementioned holding sheet 10. The holding area information is used to specify the partial areas 60 with respect to a plurality of types of holding sheets 10. More specifically, the holding area information includes area data of first to fourth partial areas 601 A to 604A in the case of the holding sheet 10A. The area data of the first partial area 604A is composed of data of coordinate values ((Xa1, Ya1) . . . (XaN, YaN)), for example, as shown in FIG. 10A. Alternatively, the area data may be composed of line segment data of an imaginary line made by connecting the coordinate points by straight lines L11 to L14 (see FIG. 10B). The area data of the first partial area specifies the first partial area 601A on the holding sheet 10A while the point O corresponding to the origin of the holding sheet 10A serves as a coordinate origin.

Regarding the second to fourth partial areas 602A to 604A, the respective positions on the holding sheet 10A are also specified on the basis of area data (XbN, YbN) to (XdN, YdN) indicative of intersections of the line segments L21 to L24, L31 to L34 and L41 to L44 in the same manner as described above. The area data of the partial areas 601A to 604A is stored on the external memory 64 while being associated with area numbers 1 to 4 (see circled numerals in FIG. 10B).

The holding area information of the holding sheet 10A is represented by coordinate values of the line segments L11 to L44 corresponding, to the base line 59. Furthermore, the holding area information is defined by a coordinate system of the cutting plotter 1 with the origin of the holding sheet 10A serving as the reference point. Differing from the holding sheet 10A, a holding sheet 10 including curved lines defining the partial areas 60 may have area data composed of coordinate values of bending points obtained by substituting the curved lines with a finite number of straight lines. Furthermore, the holding area information includes data for the purpose of display.

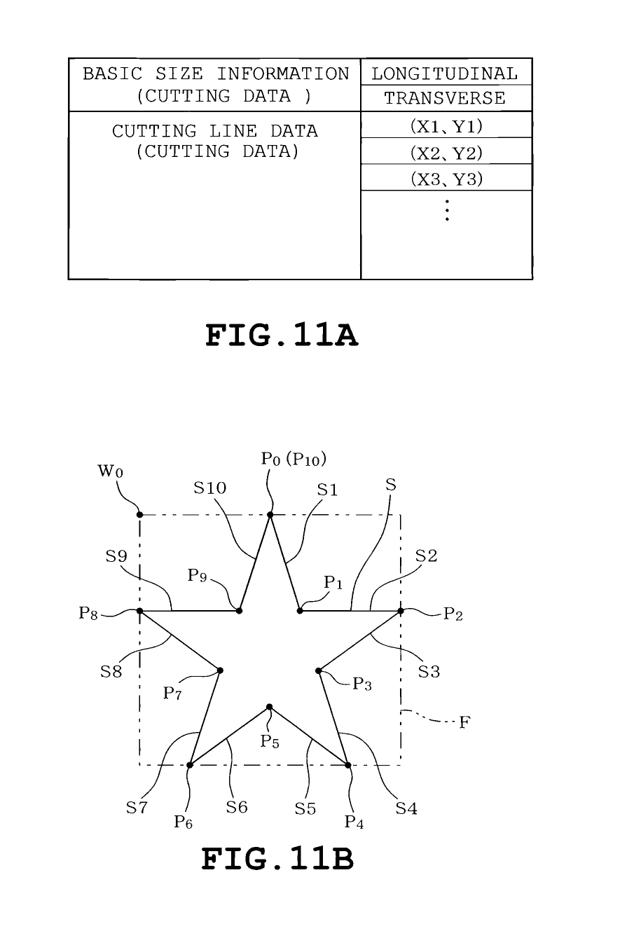

The external memory 64 stores cutting data used to cut a pattern by the cutting plotter 1. The cutting data includes basic size information and cutting line data as shown in FIG. 11A, and data for the purpose of display. The basic size information includes numeric values indicative of longitudinal and transverse sizes of the pattern and is data of an imaginary rectangular frame surrounding the pattern with a quadrangle. For example, a pattern S of “star” as shown in FIG. 11B is represented by the size of a rectangular frame F surrounding the pattern S touching apexes P₀, P₂, P₄, P₆ and P₈.

The cutting line data includes coordinate value data indicative of X-Y coordinates of the apexes of a cutting, line composed of a plurality of line segments. The coordinate value data is also defined by the coordinate system of the cutting plotter 1. More specifically, a cutting line of the pattern S includes line segments S1 to S10 and is formed into a closed star shape having a cutting start point P₀ and a cutting end point P₁₀ both of which correspond with each other, as shown in FIG. 11B. The cutting line has as cutting line data a first coordinate value (X1, Y1), a second coordinate value (X2, Y2), a third coordinate value (X3, Y3), . . . and an eleventh coordinate value corresponding to the cutting start point P₀, apexes P₁, P₂, P₃ . . . and cutting end point P₁₀ respectively. A rectangular frame F in FIG. 10B has a left upper point W₀ serving as a coordinate origin. Cutting is executed on the basis of the cutting line data while the coordinate origin is considered to correspond to the origin O.

More specifically, when the pattern S is cut, the cutter 4 of the cutting plotter 1 is relatively moved to the X-Y coordinate of the cutting start point P₀. In the relative movement, the holding sheet 10 (the cut target 6) is moved in the Y direction by the first moving unit 7 and the cutter holder 5 is moved in the X direction by the second moving unit 8. Subsequently, the blade edge 4c of the cutter 4 is caused to penetrate through the cutting start point P₀ of the cut target 6 by the third moving unit 44. The cutter 44 is relatively moved toward the coordinate of the end point P of the line segment S₁ by the first and second moving units 7 and 8, so that the cut target 6 is cut along the line segment S₁. Regarding the next line segment S₂, cutting is continuously executed with the end point P₁ of the previous line segment S₁ serving as a start point in the same manner as the line segment S₁. Thus, cutting is executed sequentially continuously regarding the line segments S₂ to S₁₀ whereby the cutting line of the pattern S or “star” is cut on the basis of the cutting line data.

In cutting the above-mentioned pattern, the processor 61 is configured to execute the arrangement setting program to identify the partial area 60 on the holding sheet 10, which partial area 60 is designated by the user. The processor 61 is further configured as an arrangement unit which automatically sets an arrangement position of the pattern relative to the cut target 6 so that the arrangement position corresponds to the identified partial area 60. Accordingly, even when a single or a plurality of cut targets 6 is affixed to any partial areas 60 of the holding sheet 10, only designation of the partial area 60 can accurately adapt the cutting position of the pattern to the position where the cut target 6 is affixed.

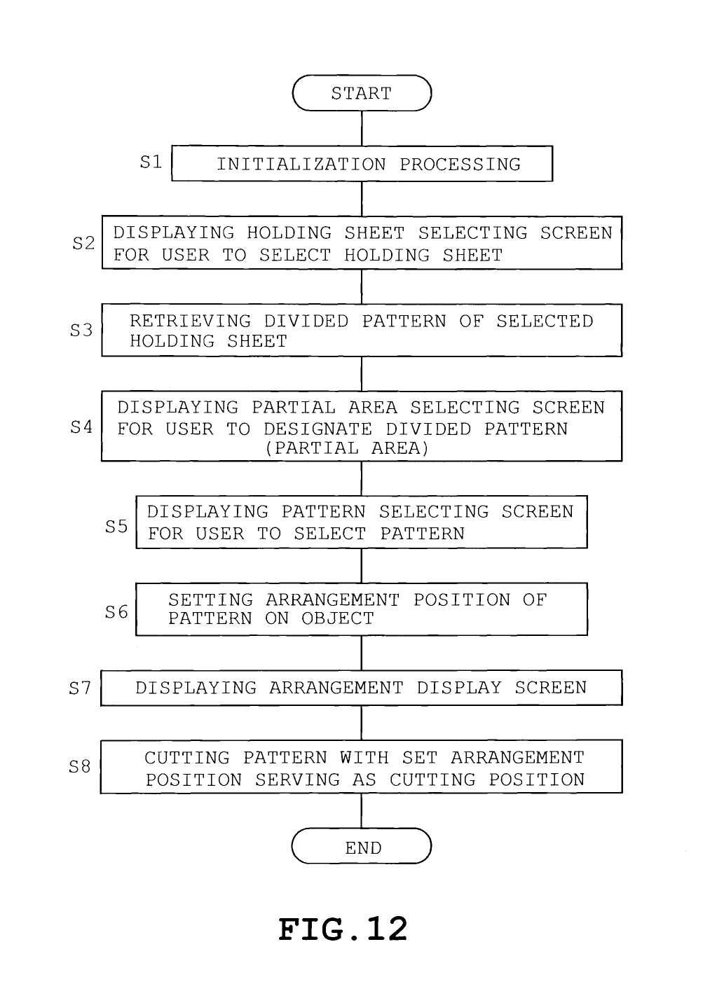

The working of the cutting plotter 1 will now be described with reference to FIGS. 12 to 15 as well as FIGS. 1 to 11B. FIG. 12 is a flowchart showing the processing flow in execution of an arrangement setting program by the processor 61. The user selects the holding sheet 10 suitable for the shape of the pattern and the shape of the cut target the user has at hand. Furthermore, the user may select a holding sheet 10 of the divided pattern suitable for the size of the pattern or the size of the cut target 6. The holding sheet 10A as shown in FIG. 1 is used in the embodiment, for example. The holding sheet 10A has partial areas 601A to 604A which have the same size as four cut targets 6A, 6b, 6C and 6D respectively. The cut targets 6A to 6D may differ in the design or a material although being pieces of paper with different colors.

The user affixes the cut targets 6A to 6D to the partial areas 601A to 604A respectively. The cut targets 6A to 6D are thus held so as to cover an entire area of the adhesive layer 10v serving as the holding area and so as not to overlap one another. The user then sets the holding sheet 10 holding the cut targets 6A to 6D through the opening 2a of the cutting plotter 1. The user then operates one of the operation switches of the operation device 65 to instruct “paper feed.” As a result, the processor 61 controls the first moving unit 7 so that the holding sheet 10 is fed backward. The processor 61 further executes an initializing process to set the origin O of the holding sheet 10 (step S1).

On the other hand, the processor 61 generates an image signal based on data of the holding sheet 10 stored on the external memory 64, transmitting the signal to the display 9. As a result, the holding sheet selecting screen as shown in FIG. 13 is displayed on the display 9. The holding sheet selecting screen is provided for selecting a type of holding sheet 10 to be used by the user. FIG. 13 exemplifies eight of a plurality of types of holding sheets 10 with reduced scales of base lines 59′. The user operates one of the operation switches of the operation device 65 to select a type of holding sheet 10A surrounded by a broken line in FIG. 13 (step S2).

As a result, holding area information of the selected holding sheet 10A is retrieved to be stored on the RAM 63 (step S3). Thereafter, a partial area selecting screen (not shown) is displayed. The partial areas 601A to 604A serving as the holding areas are displayed on the partial area selecting screen. More specifically, the holding sheets 10A are displayed by scaled-back base lines 59′ on the partial area selecting screen in the same manner as holding sheet selecting careen, for example. In this case, area numbers 1 to 4 corresponding to the respective partial areas 601A to 604A may also be displayed together with the holding sheets 10A, as shown in FIG. 10B. While viewing the partial area screen, the user operates the operation device 65 to designate a desired one of the area numbers 1 to 4, whereby one of the partial areas 601A to 604A corresponding to one of the cut targets 6A to 6D desired to be cut is specified (step S5).

Next, the pattern selecting screen is displayed on the display 9 in order that the user may select a desired pattern, as shown in FIG. 14. The user operates one of the operation switches of the operation device 65 to select a desired pattern (the pattern S of “star,” for example; and step S5). As a result, cutting data of the selected pattern S is retrieved from the external memory 64. The processor 61 then sets an arrangement position of the selected pattern S on the cut target 6 by relating the selected pattern S to the partial area designated at step S4 (step S6). For example, assume now that the partial area 603A of area number 3 has been designated by the user at step S4. In this case, the processor 61 converts a coordinate value of the cutting data (the cutting line data) on the basis of area data of partial area 603A so that the pattern S is located in an area inside the line segments L32 to L34.

In more detail, the point O corresponding to the origin of the holding sheet 10A is set as a coordinate origin with respect to the arrangement position of the pattern S, as shown in FIG 10C. The cutting data of the pattern S is then converted to such a coordinate value that blank spaces G of 5 mm are formed between the line segment L34 of the partial area 603A and the left side of the rectangular frame F and between the line segment L31 and a rear side of the rectangular frame F respectively. As a result, the arrangement of the pattern S is automatically set so that the cutting line thereof reliably falls within the cut target 6C and is located closer to one corner of the cut target 6C. In this case, the coordinate value set by the automatic arrangement of the pattern S is stored on the RAM 63 as the cutting data of the pattern S.

The processor 61 generates an image signal indicative of the image of the pattern S located at the set arrangement position, based on information stored on the RAM 63, more specifically, the information about the holding area of the selected holding sheet 10A and the coordinate value set by automatic arrangement of the pattern S. The processor 61 then transmits the image signal to the display 9, whereby the display 9 displays an arrangement display screen which displays the pattern S assuming the set arrangement position as shown in FIG. 15 (step S7). On the arrangement display screen are displayed a base line 59′ representing the holding sheet 10A on a suitable scale and the pattern S arranged, inside the base line 59′. Consequently, the user can view the arrangement position of the pattern S.

The user then operates one of the operation switches of the operation device 65 to instruct start of the cutting, whereby the cutting of the pattern S is started by the cut mechanism 58 on the basis of the cutting data. (step S8). The cutting is executed under the condition that the arrangement position of the pattern S is a cutting position of the cut target 6C, that is, the coordinate origin O of the post-conversion cutting data corresponds to the origin O of the holding sheet 10.

In execution of the cutting by the cutting plotter 1, the solenoid 57 is actuated so that the cut target 6 is pressed by the contact portion 56f. Furthermore, the cut target 6 is held by the adhesion of the adhesive layer 10v of the holding sheet 10 so as to be prevented from stirring or displacement. Still furthermore, the contact portion 56f of the pressing member 56 is made of the material with a lower coefficient of friction although the pressing member 56 is moved relative to the cut target 6 during the cutting. This can reduce a frictional force caused between the contact portion 56f and the cut target 6 to a value as small as possible. Consequently, the cut target e can be held more reliably while being prevented from displacement due to the frictional force, and accordingly, the cut target 6 can be cut accurately on the basis of the cutting data. The whole pattern S of “star” is thus cut out of the cut target 6C.

The above-described steps S2 to S4 serve as a designation routine of designating the partial area 60 that is at least a part of the holding area of the holding sheet 10, which part holding the cut target 6. The processor 61 executing the steps S2 to S4, the operation switches of the operation device 65 and the display 9 serve as a designating unit. Furthermore, the designation routine includes a pattern selection routine of alternatively selecting one of a plurality of types of divided patterns (the partial areas 60 of each configuration). The processor 61 executing the pattern selection routine functions as a pattern selecting unit, together with the operation device 65 and the display 9.

The processor 61 in the embodiment thus serves as an arranging unit which executes an arrangement routine of setting the arrangement position of the cut target 6 by relating the pattern S selected by the pattern selecting unit to the partial area 60 designated in the designation routine (step S6). The pattern is cut by the cut mechanism 58 with the arrangement position set in the arrangement routine serving as a cutting position of the cut target 6. According to this configuration, the arrangement position of the pattern on the cut target 6 is automatically set by the arrangement routine while the selected pattern is related to the partial area 60 designated by the designation routine. Accordingly, even when a single or a plurality of cut targets 6 is affixed to any partial areas 60 of the holding sheet 10 only designation of the partial area 60 can accurately adapt the cutting position of the pattern to the position where the cut target 6 is affixed. Consequently, a desired pattern can easily be cut without troublesome work such as confirmation and adjustment of the arrangement position of the pattern.

The partial areas 60 are obtained by dividing the holding area into a plurality of areas each having a predetermined size. Accordingly, waste of the cut target can be reduced since the cutting is executed using the cut target 6 which has substantially the same size as a single partial area 60 or a plurality of partial areas 60. Furthermore, even when the cut target 6 is affixed to any one of a plurality of partial areas 60, the pattern can be cut at a desired position by designating the partial area 60.

A plurality of types of patterns is set as divided patterns different from each other. The designation routine includes the pattern selection routine of alternatively selecting one of the divided patterns. According to this configuration, a most suitable divided pattern can he selected according to the configuration and size of the pattern when a partial area 60 of a desired divided pattern is alternatively selected by the pattern selection routine. Furthermore, waste of the cut target 6 can further be reduced when the cutting is executed using the cut target 6 having substantially the same pattern as any one of a plurality of types of divided patterns, according to the configuration and/or the size of the pattern.

The holding sheet 10 is provided with the markers corresponding to a plurality of types of divided patterns respectively. According to this configuration, the user can accurately affix the cut target 6 to the holding sheet 10 by mating the cut target 6 with the markers, and the cutting position of the pattern can be prevented from displacement relative to the cut target 6.

A plurality of types of holding sheets 10 is prepared which differs in the markers corresponding to the respective divided patterns. Accordingly, the user can suitably select and use the holding sheet 10 with the marker according, to the configuration and/or size of the pattern or the configuration and/or size of the cut target the user has at hand. The markers are the base line 59 provided on the holding sheet 10. Consequently, the user can view the divided pattern as the base line 59, with the result that the cut target 6 can accurately be affixed along the base line 59.

The processor 61 is configured to execute the display routine of displaying the pattern while the pattern is related to the arrangement position set by the arrangement unit (step S7). According to this configuration, the user can view the pattern selected by the pattern selecting unit, together with the arrangement position thereof on the display unit. Furthermore, the user can confirm, before the cutting, that the arrangement position is the predetermined cutting position according to the position of cut target 6 affixed to the holding sheet 10.

The foregoing embodiment described with reference to the accompanying drawings is not restrictive but may he modified or expanded as follows. Although the cutting plotter 1 has been applied to the cutting plotter in the foregoing embodiments, the cutting plotter 1 may be applied to various types of apparatuses having respective cutting functions.

The arrangement setting program includes step S4 where the partial area selecting screen is displayed for selection of a partial area 60 and step S5 where the pattern selecting screen is displayed for selection of a pattern. The steps S4 and S5 may be carried out in reverse order. Thus, even when a partial area 60 is selected after selection of a pattern, an arrangement position on the cut target 6 can be set by relating the arrangement position to the partial area 60, whereupon this modified form can achieve the same advantageous effects as the foregoing embodiment.

The pattern selecting unit may include the display 9 and a touch panel (not shown) provided on the front of the display 9 and having a plurality of touch keys further including transparent electrodes. In this configuration, when the touch keys are depressed with a finger of the user or a touch pen, various parameters may be set and various functions may be instructed as well as selection of a pattern and a holding sheet 10.

The markers should not be limited to the above-described base line 59 and the identification mark indicated by the numerals. For example, although the base line 59 is a black solid line in the foregoing, embodiment, the base line 59 may be red, yellow or in any other color. The base line 59 may be a broken line or any other type of line. Furthermore, a thickness or width of the base line 59 may be changed in an appropriate manner. The identification mark may be a character or a symbol, instead of the numeral. Still furthermore, the partial areas 60 may be colored in different colors. Thus, any markers corresponding to the respective divided patterns may be employed.

The arrangement setting program stored on the storage unit in the cutting plotter 1 may be stored by a non-transitory computer readable storage medium such as a USB memory, CD-ROM, to flexible disc, DVD or a flash memory. In this case, the arrangement setting program may be loaded from the storage medium to a computer of each one of various apparatuses provided with a cutting function, whereby the same working and advantageous effects as those in the foregoing embodiments may be achieved.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting plotter comprising:
a cut mechanism configured to cut a pattern from a cut target by relatively moving a cutting blade and a holding member, the holding member being configured to hold the cut target and being to be set on the cutting plotter;
an operation device configured to receive input;
a processor; and
a memory storing computer-readable instructions therein, wherein the computer-readable instructions instruct the cutting plotter to execute steps comprising:
designating a partial area based on an input received by the operation device, the partial area being a pan of a holding area in which the cut target is held;
selecting a certain pattern from plural patterns based on an input received by the operation device;
determining a position of the certain pattern on the cut target, the position being included in the partial area; and
instructing the cut mechanism to cut the certain pattern from the position on the cut target determined by the determining.

2. The cutting plotter according to claim 1, wherein
the designating comprises designating the partial area from plural areas into which the holding area is divided by a predetermined size.

3. The cutting plotter according to claim 2, wherein
the designating further comprises:
selecting one of plural divided patterns different from each other, each of the plural divided patterns being a pattern of a plurality of the partial areas into which the holding area is divided.

4. The cutting plotter according to claim 3 further comprising:
a display, wherein
the computer-readable instructions, stored in the memory, instruct the cutting plotter to execute steps further comprising:
sending an instruction that cause the display to display a marker, which is included in the holding member, corresponding to the plural divided patterns.

5. The cutting plotter according to claim 3 further comprising:
a display, wherein
the computer-readable instructions, stored in the memory, instruct the cutting plotter to execute steps further comprising:
sending an instruction that cause the display to display plural markers, which are included in the holding member and different from each other, corresponding to the plural divided patterns.

6. The cutting plotter according to claim 4, wherein
the marker is a base line corresponding to the plural divided patterns.

7. The cutting plotter according to claim 1 further comprising:
a display, wherein
the computer-readable instructions, stored in the memory, instruct the cutting plotter to execute steps further comprising:
sending an instruction that causes the display to display the certain pattern on the position determined by the determining.

8. The cutting plotter according to claim 1, wherein,
the computer-readable instructions, stored in the memory, instruct the cutting plotter to execute steps further comprising:
sending an instruction that causes the display to display a plurality of the partial areas, wherein
the designating comprises designating one of the plurality of the partial patterns, which are displayed on the display, based on an input received by the operation device

9. The cutting plotter according to claim 7, wherein the computer-readable instructions, stored in the memory, instruct the cutting plotter to execute steps further comprising:
sending an instruction that causes the display to display the plural patterns, wherein
the selecting comprises selecting the certain pattern from the plural patterns, which are displayed on the display, based on an input received by the operation device.

10. A non-transitory computer-readable medium storing computer-readable instructions that, when executed by a processor of a cutting plotter, cause the processor to perform the steps of:
designating a partial area based on an input received by an operation device of the cutting plotter, the partial area being a part of a holding area in which a cut target is held;
selecting a certain pattern from a plural patterns based on an input received by the operation device; and
determining a position of the certain pattern on the cut target, the position being included in the partial area.

11. The non-transitory computer-readable medium according to claim 10, wherein
the instructions, when executed by the processor, further cause the processor to perform the steps of
sending an instruction that causes a cut mechanism to cut the certain pattern from the position on the cut target determined by the determining, the cut mechanism cuts the certain pattern from the cut target by relatively moving a cutting blade and a holding member on which the cut target is held.

12. The non-transitory computer-readable medium according to claim 10, wherein
the designating comprises designating the partial area from plural areas into which the holding area is divided by a predetermined size.

13. The non-transitory computer-readable medium according to claim 10, wherein
the designating further comprises:
selecting, one of plural divided patterns different from each other, each of the plural divided patterns being a pattern of a plurality of the partial areas into which the holding area is divided.

14. The non-transitory computer-readable medium according to claim 10, wherein
the instructions, when executed by the processor, further cause the processor to perform the steps of:
sending an instruction that causes a display of the cutting plotter to display the certain pattern on the position determined by the determining.

15. The non-transitory computer-readable medium according to claim 14, wherein
the instructions, when executed by the processor, further cause the processor to perform the steps of:
sending an instruction that causes the display to display a plurality of the partial areas, wherein
the designating comprises designating one of the plurality of the partial patterns, which are displayed on the display, based on an input received by the operation device.

16. The non-transitory computer-readable medium according to claim 14, wherein
the instructions, when executed by the processor, further cause the processor to perform the steps of:
sending an instruction that causes the display to display the plural patterns, wherein
the selecting comprises selecting the certain pattern from the plural patterns, which are displayed on the display, based on an input received by the operation device.
